(19) United States
(12) Patent Application Publication
(10) Pub. No.: US 2011/0083814 A1
(43) Pub. Date: Apr. 14, 2011

(54) CORD-OPERATED ROMAN SHADE

(76) Inventor: Patrick Lane, Lake Mary, FL (US)

(21) Appl. No.: 12/578,885

(22) Filed: Oct. 14, 2009

(51) Int. Cl. E06B 9/24; A44B 18/00

(52) U.S. Cl. 160/84.04

(57) ABSTRACT

A cord-operated roman shade includes a top rail for being mounted on and supporting a shade panel on a vertical surface, at least one cord attached to the bottom of the shade panel for raising the shade panel when the cord is pulled downwardly and lowering the shade panel when the cord is released and allowed to move upwardly. A cord guide positioned on the top rail includes an elongate body having two laterally spaced-apart, substantially right-angle cord guiding surfaces on which the cord moves during operation for converting downward pulling movement of the cord into the upward raising movement of the shade panel and converting upward releasing movement of the cord into downward lowering movement of the shade panel, and a plurality of vertically spaced-apart lift attachments carried by the shade panel through which the cord extends for relative movement during shade operation.

### TECHNICAL FIELD OF THE INVENTION

This invention relates generally to a shade, and more particularly to a cord-operated Roman shade.

### BACKGROUND OF THE INVENTION

In typical window shade arrangements, a top rail assembly includes pulleys that direct cords by which a shade is lifted as the shade wraps around a cylindrical rod. The pulleys typically guide the cords through quarter turns and must sustain the weight of the shade and the forces applied by users who may not always be gentle. Thus, the pulleys are subject to wear and are typically among the highest cost components of typical top-rail assemblies.

An improved cord-operated roman shade is needed.

### BRIEF SUMMARY OF THE INVENTION

Accordingly to at least one embodiment of the invention, a cord-operated roman shade, which is of the type having a foldable shade panel sized to cover an opening when in a closed position, includes a top rail for being mounted on and supporting the shade panel on a vertical surface, at least one cord attached to the bottom of the shade panel for raising the shade panel when the cord is pulled downwardly and lowering the shade panel when the cord is released and allowed to move upwardly, a cord guide positioned on the top rail, and including an elongate body having two laterally spaced-apart, substantially right-angle cord guiding surfaces on which the cord moves during operation for converting downward pulling movement of the cord into the upward raising movement of the shade panel and converting upward releasing movement of the cord into downward lowering movement of the shade panel, and a plurality of vertically spaced-apart lift attachments carried by the shade panel through which the cord extends for relative movement during operation, the lift attachments adapted to raise the shade panel into a progressively overlapping array of folds as the shade panel is raised by the cord and lower the shade panel into a progressively non-overlapping position as the shade panel is lowered by the cord.

In at least one example, the lift attachments comprise rings sized to permit the cord to pass freely therethrough as the shade panel is raised and lowered.

In at least one example, the foldable panel comprises a plurality of laterally extending, connected panel segments.

In at least one example, a valence covers the top rail.

In at least one example, a valence is releaseably attached to the top rail for covering the top rail.

In at least one example, retention straps encircle and retain the shade panel in its raised position.

In at least one example, the cord guide includes first and second parallel cord channels for permitting use of first and second cords to separately and simultaneously raise and lower the shade panel from laterally spaced-apart positions.

Accordingly to at least one other embodiment of the invention, a cord-operated roman shade, which is of the type having a foldable panel sized to cover an opening when in a closed position, includes a top rail for being mounted on and supporting the shade panel on a vertical surface, first and second spaced-apart cords attached to the bottom of the shade panel for raising the shade panel when the cords are simultaneously pulled downwardly and lowering the shade panel when the cords are simultaneously released and allowed to move upwardly together, a cord guide positioned on the top rail, and including an elongate body having two laterally spaced-apart, substantially right-angle cord guiding surfaces on which the first and second cords move during operation for converting downward pulling movement of the cords into the upward raising movement of the shade panel and converting upward releasing movement of the cords into downward lowering movement of the shade panel, and first and second parallel cord channels positioned between the right-angle cord guiding surfaces for permitting the first and second cords to separately and simultaneously raise and lower the shade panel from laterally spaced-apart positions, and first and second pluralities of vertically spaced-apart lift attachments carried by the shade panel in laterally spaced part relation from each other and through which respective ones of the first and second cords extend for relative movement during operation, the lift attachments adapted to raise the shade panel into a progressively overlapping array of folds as the shade panel is raised by the first and second cords and lower the shade panel into a progressively non-overlapping position as the shade panel is lowered by the first and second cords.

In at least one example, the lift attachments include rings sized to permit the cord to pass freely therethrough as the shade panel is raised and lowered

In at least one example, the foldable panel includes a plurality of laterally extending, connected panel segments.

In at least one example, a valence is provided for covering the top rail.

In at least one example, a valence releasably attaches to the top rail for covering the top rail.

In at least one example, retention straps for encircling and retaining the shade panel in its raised position is provided.

According to at least one other embodiment of the invention, a cord-operated roman shade of the type having a foldable fabric panel comprised of a plurality of laterally extending, connected panel segments collectively sized to cover an opening when in a closed position, includes a top rail for being mounted on and supporting the shade panel on a vertical surface, first and second spaced-apart cords attached to the bottom of the shade panel for raising the shade panel when the cords are simultaneously pulled downwardly and lowering the shade panel when the cords are simultaneously released and allowed to move upwardly together, first and second cord guides positioned in laterally spaced apart relation on the top rail, and each including an elongate body having substantially right-angle cord guiding surfaces on which the first and second cords move during operation for converting downward pulling movement of the cords into the upward raising movement of the shade panel, and converting upward releasing movement of the cords into downward lowering movement of the shade panel, the first and second parallel cord channels being positioned between the right-angle cord guiding surfaces for permitting the first and second cords to separately and simultaneously raise and lower the shade panel from laterally spaced-apart positions, first and second pluralities of vertically spaced-apart lift rings carried by the shade panel panel in laterally spaced part relation from each other and through which respective ones of the first and second cords extend for relative movement during operation, the lift attachments adapted to raise the shade panel into a progressively overlapping array of folds as the shade panel is raised by the first and second cords and lower the shade panel into a progressively non-overlapping position as the shade panel is lowered by the first and second cords, a valence covering the top rail, and complementary touch fastener retention straps for encircling and retaining the shade panel in its raised position.

### BRIEF DESCRIPTION OF THE DRAWINGS

The subject matter that is regarded as the invention may be best understood by reference to the following description taken in conjunction with the accompanying drawing figures in which:

FIG. 1 is a front elevation view of a raised cord-operated roman shade according to one embodiment of the present invention;

FIG. 2 is another front elevation view of the shade of FIG. 1;

FIG. 3 is a back elevation view of the shade of FIG. 1;

FIG. 4 is a perspective view of a side portion of the shade of FIG. 1;

FIG. 5 is a perspective view of the shade of FIG. 1 shown in a partially lowered position;

FIG. 6A-6F are views of a first cord guide shown in top plan, bottom plan, front elevation, left-side elevation, right-side elevation, and back elevation respectively;

FIG. 7A-7F are views of a second cord guide shown in top plan, bottom plan, front elevation, left-side elevation, right-side elevation, and back elevation respectively;

FIG. 8 is a perspective view of the cord guides of FIGS. 6A and 7A; and

FIG. 9 is an exploded perspective view of the roman shade of FIG. 1.

### DETAILED DESCRIPTION OF THE INVENTION

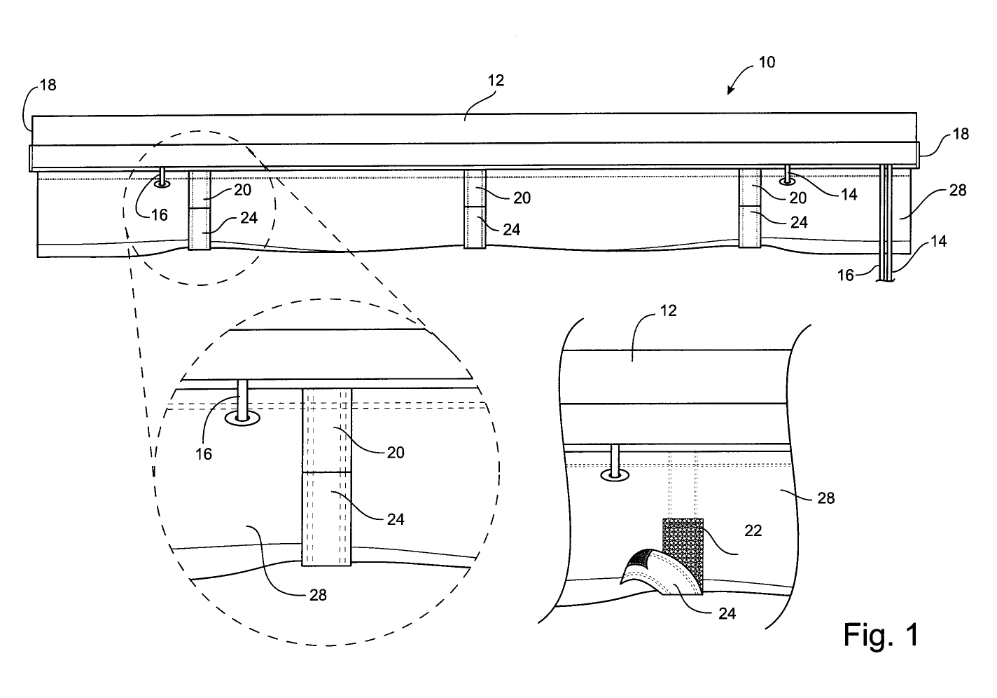

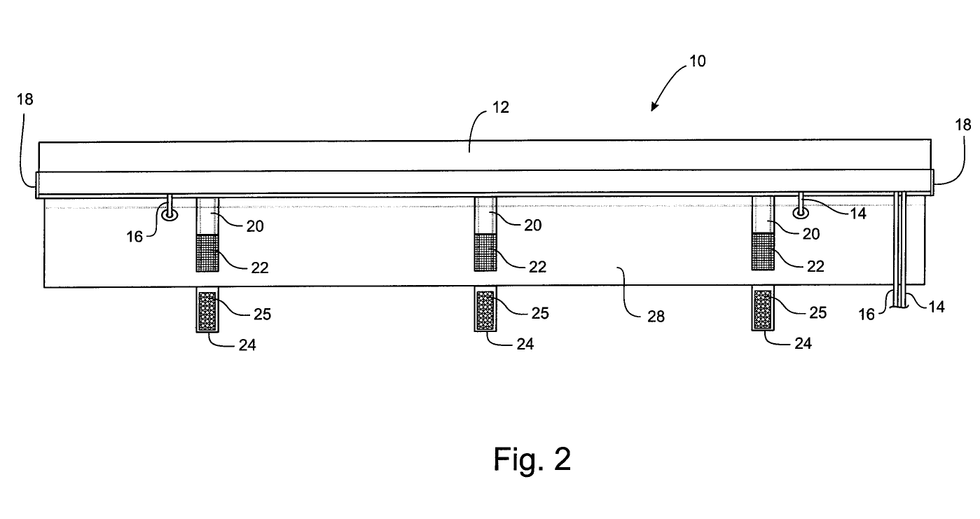

Referring to the drawings wherein identical reference numerals denote the same elements throughout the various views, FIGS. 1 and 2 illustrate a cord-operated roman shade 10, according to one embodiment of the present invention. The shade 10 includes a top rail 12 for being mounted on a vertical surface such as a wall to support the shade panel 28, cords 14 and 16 for raising and lowering the left and right sides of the shade panel 28, and a pair of cord guides 18a and 18b that are capable of converting downward pulling movement of the cords 14 and 16 into upward raising movement of the shade panel 28 and upward releasing movement of the cords 14 and 16 into downward lowering movement of the shade panel 28.

In FIG. 1, retention straps 20 and 24 encircle and retain the shade panel 28 in its raised position. The retention straps 20 include fabric areas 22 having hooks and retention straps 24 include fabric areas 25 having loops for positioning in overlapping relation to secure ends of the straps 20 and 24 together to secure the shade panel 28 in its raised position.

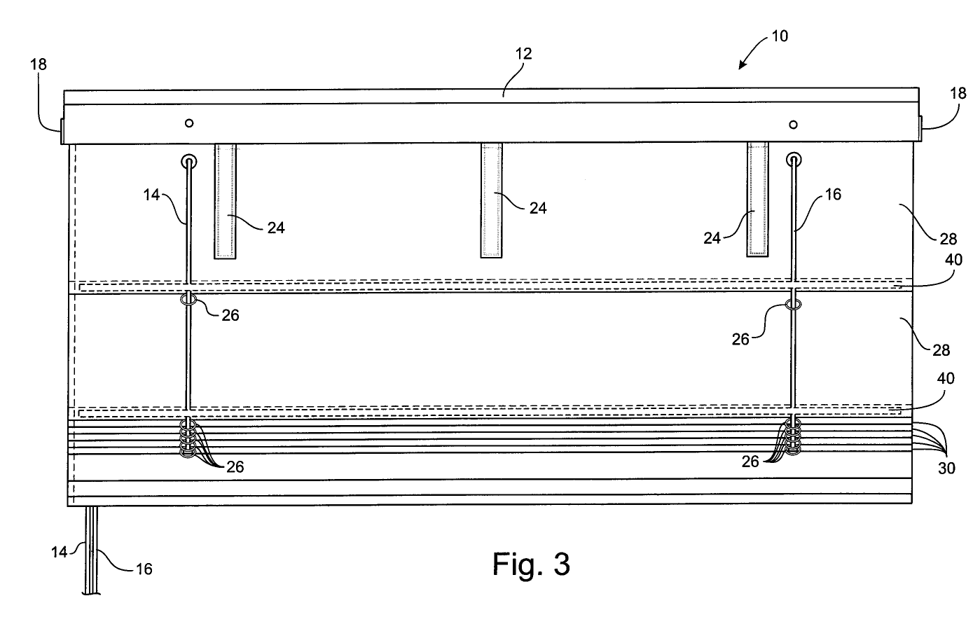

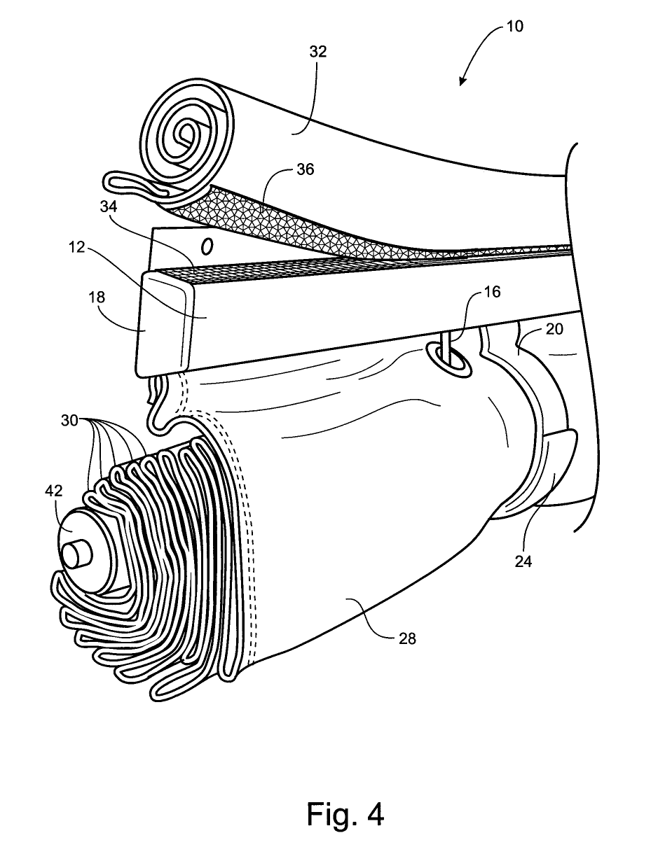

As can be seen in FIG. 3, the roman shade 10 includes lift attachments 26 carried by the shade panel 28. The cords 14 and 16 extend through the lift attachments 26 and the shade panels are raised into a progressively overlapping array of folds 30 as the shade panel 28 is raised by the cords 14 and 16. The shade panels 28 are lowered into a progressively non-overlapping position as the shade panel 28 is lowered by the cords 14 and 16. The lift attachments 26 are formed in this example as rings sized to permit the cords 14 and 16 to pass freely through them as the shade is raised and lowered. The shade panel 28 is shown in a partially raised position in FIG. 3 and in a fully raised position in FIG. 4.

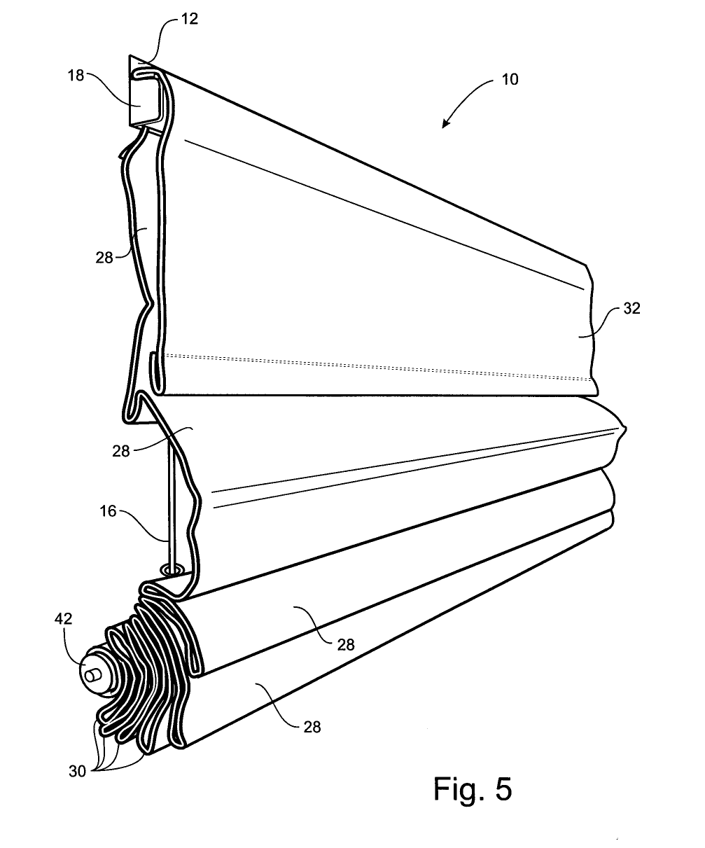

A shown in FIG. 4, a valence 32 is releasably attached to the top rail 12 and covers the top rail 12 in FIG. 5. The top rail 12 has hooks 34 and the valence 32 has loops 36 that releasably attach together to attach the valence 32 to the top rail 12.

Internal rods 40 (FIG. 3) are sewn into the shade panel 28 to hold the folds in straight positions as shown in FIG. 4. A bottom rod 42 is positioned in the bottom shade panel 28, adding weight to the shade panel 28 to help hold it stable and flat.

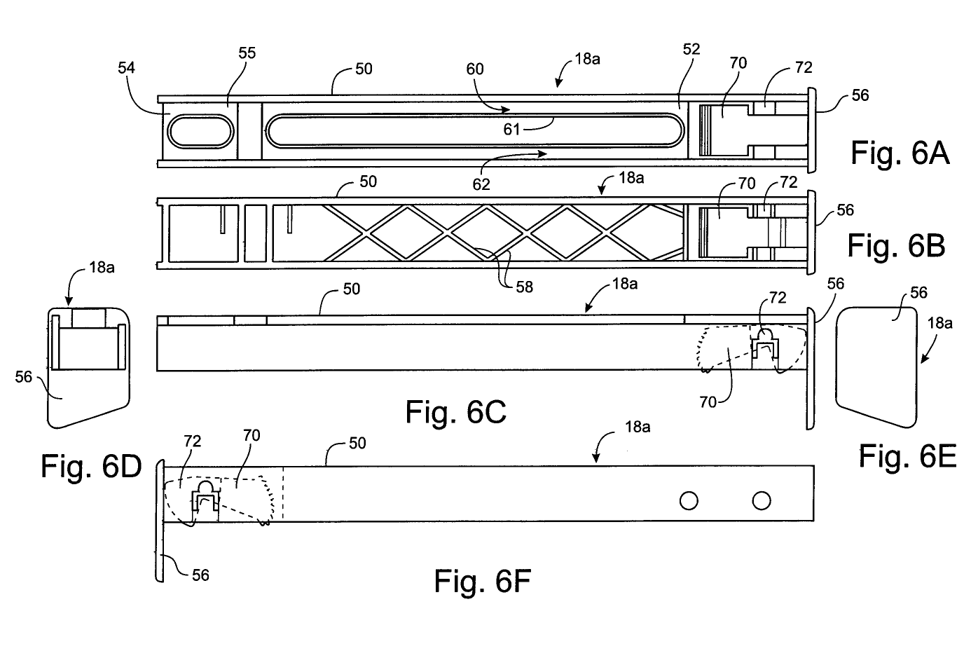

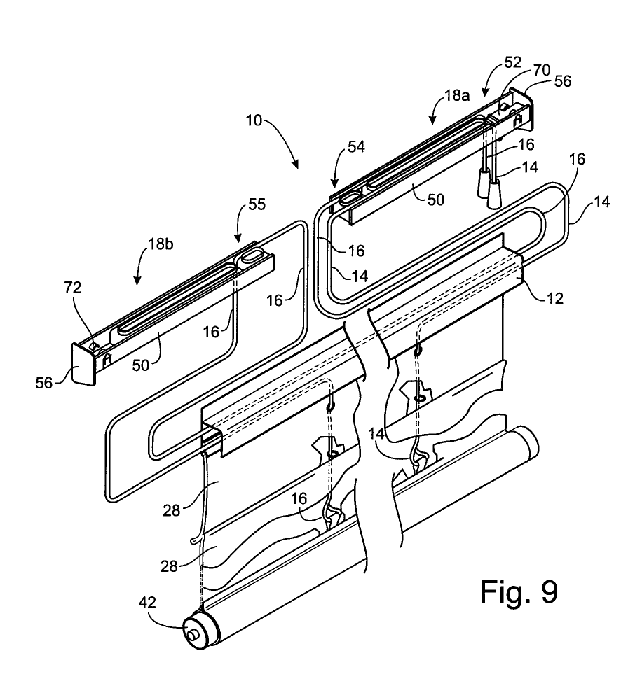

As shown in FIG. 6A-6F, the cord guide 18a, now shown separate from the top rail 12 (FIG. 9), includes an elongate body 50 having two laterally spaced-apart, substantially right-angle cord guiding surfaces 52, 54 and 55. The cord guiding surfaces 52, 54 and 55 during operation, convert downward pulling movement of the cords 14 and 16 into the upward raising movement of the shade panel 28 and convert upward releasing movement of the cords 14 and 16 into downward lowering movement of the shade panel 28.

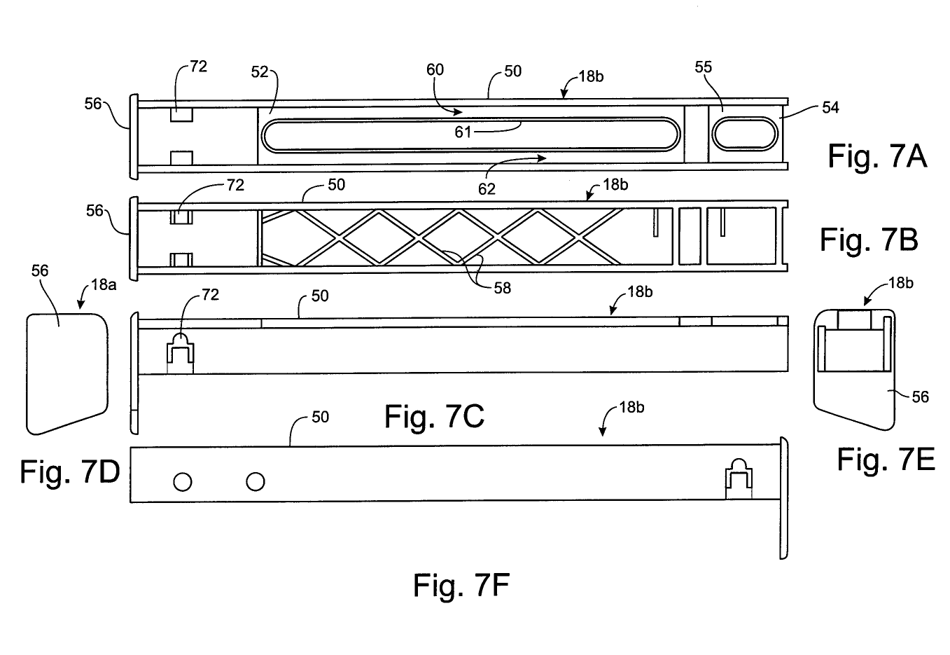

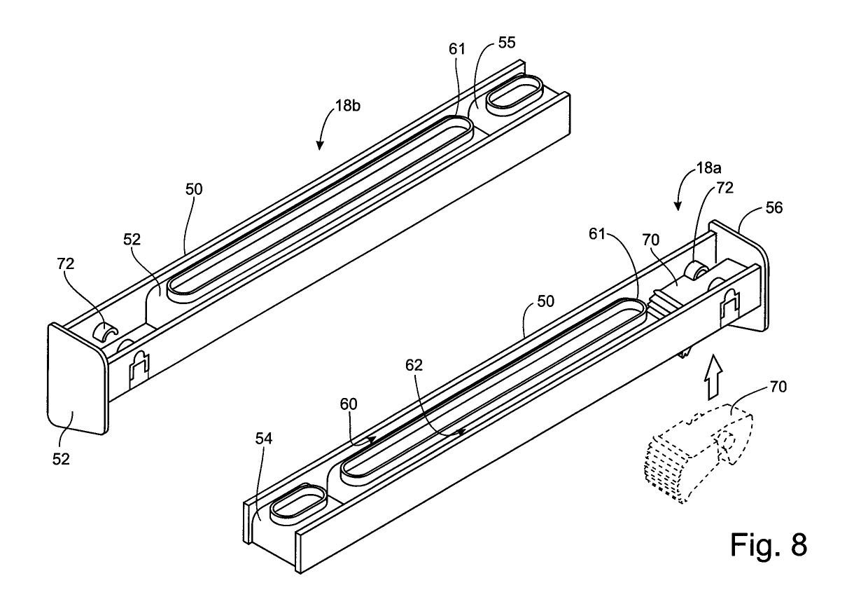

Each elongate body 50 has and end plate 56 positioned against a corresponding end of the top rail 12 when the roman shade 10 is fully assembled as shown in FIG. 4. As shown in FIG. 6B, the bottom side of the elongate body 50 has ribs 58 for additional strength. As shown in FIGS. 6 and 8, the elongate body 50 includes a raised central wall 61 positioned between two cord-guiding pathways 60 and 62 to guide the cords 14 and 16 as shown in FIG. 9. FIGS. 7A-7F are views of the second cord guide 18b, corresponding to the views in FIGS. 6A-6F of the first cord guide 18a.

The roman shade 10, as shown in FIG. 9, includes two cord guides 18a and 18b, with one being positioned at each end of the top rail 12. The paths of the cords 14 and 16 through the shade 10 are shown in FIG. 9. The cord 14 moves on the cord guiding surfaces 52 and 54 of the first cord guide 18a, then along the cord-guiding pathway 60, extends through the lift attachments 26 along one side of the shade panel 28, and is attached to the lowest portion of the shade panel 28 near the bottom rod 42. The cord 16 moves on the cord guiding surface 52 of the first cord guide 18a, then along the cord-guiding pathway 62. From there the cord 16 extends across to the second cord guide 18b, where it moves on the cord guiding surface 55 of the second cord guide 18b, extends through the lift attachments 26 along the other side of the shade panels 28, and is attached to the lowest portion of the shade panel 28 near the bottom rod 42.

A clamp 70 positioned in the cord guide 18a, as shown in FIGS. 6A-6b and FIG. 8, stops the movement of the cords 14 and 16 when a preferred position is reached. The clamp 70 moves on a pivot point 72 on the cord guide 18a between locking and releasing positions. Both cord-guiding pathways 60 and 62 guide their respective cords 14 and 16 to be engaged by the clamp 70, so the two cords 14 and 16 are controlled by a single stopping mechanism and the number of parts required to manufacture the shade 10 is minimized. The free ends of both cords 14 and 16 are pulled and released to raise and lower the shade panel 28, and a typically adjusted together to raise and lower both sides of the shade together.

The top rail 12 can be extruded for a suitable material such as high strength plastic, and the cord guide 18 can be molded from the same or other material. The cords 14 and 16 can be made of synthetic and/or natural fibers. The shade panel 28 can be constructed of woven fabric made of synthetic and/or natural fibers and may come in a variety of colors and patterns to suit the tastes of various consumers.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A cord-operated roman shade of the type having a foldable shade panel sized to cover an opening when in a closed position, comprising:
(a) a top rail for being mounted on and supporting the shade panel on a vertical surface;
(b) at least one cord attached to the bottom of the shade panel for raising the shade panel when the cord is pulled downwardly and lowering the shade panel when the cord is released and allowed to move upwardly;
(c) a cord guide positioned on the top rail, and including an elongate body having two laterally spaced-apart, substantially right-angle cord guiding surfaces on which the cord moves during operation for converting downward pulling movement of the cord into the upward raising movement of the shade panel and converting upward releasing movement of the cord into downward lowering movement of the shade panel; and
(d) a plurality of vertically spaced-apart lift attachments carried by the shade panels through which the cord extends for relative movement during operation, the lift attachments adapted to raise the shade panel into a progressively overlapping array of folds as the shade panel is raised by the cord, and lower the shade panel into a progressively non-overlapping position as the shade panel is lowered by the cord.

2. A cord-operated roman shade according to claim 1, wherein the lift attachments comprise rings sized to permit the cord to pass freely therethrough as the shade panel is raised and lowered.

3. A cord-operated roman shade according to claim 1, wherein the foldable shade panel comprises a plurality of laterally extending, connected panel segments.

4. A cord-operated roman shade according to claim 1, and including a valence covering the top rail.

5. A cord-operated roman shade according to claim 1, and including a valence releaseably attached to the top rail for covering the top rail.

6. A cord-operated roman shade according to claim 1, and including retention straps for encircling and retaining the shade in its raised position.

7. A cord-operated roman shade according to claim 1, wherein the cord guide includes first and second parallel cord channels for permitting use of first and second cords to separately and simultaneously raise and lower the shade from laterally spaced-apart positions.

8. A cord-operated roman shade of the type having a foldable shade panel sized to cover an opening when in a closed position, comprising:
(a) a top rail for being mounted on and supporting the shade panel on a vertical surface;
(b) first and second spaced-apart cords attached to the bottom of the shade for raising the shade panel when the cords are simultaneously pulled downwardly and lowering the shade panel when the cords are simultaneously released and allowed to move upwardly together;
(c) a cord guide positioned on the top rail, and including an elongate body having two laterally spaced-apart, substantially right-angle cord guiding surfaces on which the first and second cords move during operation for converting downward pulling movement of the cords into the upward raising movement of the shade panel and converting upward releasing movement of the cords into downward lowering movement of the shade, and first and second parallel cord channels positioned between the right-angle cord guiding surfaces for permitting the first and second cords to separately and simultaneously raise and lower the shade panel from laterally spaced-apart positions; and
(d) first and second pluralities of vertically spaced-apart lift attachments carried by the shade panel in laterally spaced part relation from each other and through which respective ones of the first and second cords extend for relative movement during operation, the lift attachments adapted to raise the shade panel into a progressively overlapping array of folds as the shade panel is raised by the first and second cords and lower the shade panel into a progressively non-overlapping position as the shade panel is lowered by the first and second cords.

9. A cord-operated roman shade according to claim 8, wherein the lift attachments comprise rings sized to permit the cord to pass freely therethrough as the shade panel is raised and lowered.

10. A cord-operated roman shade according to claim 8, wherein the foldable panel comprises a plurality of laterally extending, connected panel segments.

11. A cord-operated roman shade according to claim 8, and including a valence covering the top rail.

12. A cord-operated roman shade according to claim 8, and including a valence releasably attached to the top rail for covering the top rail.

13. A cord-operated roman shade according to claim 8, and including retention straps for encircling and retaining the shade panel in its raised position.

14. A cord-operated roman shade of the type having a foldable fabric panel comprised of a plurality of laterally extending, connected panel segments collectively sized to cover an opening when in a closed position, comprising:
(a) a top rail for being mounted on and supporting the shade panel on a vertical surface;
(b) first and second spaced-apart cords attached to the bottom of the shade panel for raising the shade panel when the cords are simultaneously pulled downwardly and lowering the shade panel when the cords are simultaneously released and allowed to move upwardly together;
(c) first and second cord guides positioned in laterally spaced apart relation on the top rail, and each including an elongate body having substantially right-angle cord guiding surfaces on which the first and second cords move during operation for converting downward pulling movement of the cords into the upward raising movement of the shade panel, and converting upward releasing movement of the cords into downward lowering movement of the shade panel, the first and second parallel cord channels being positioned between the right-angle cord guiding surfaces for permitting the first and second cords to separately and simultaneously raise and lower the shade panel from laterally spaced-apart positions;
(d) first and second pluralities of vertically spaced-apart lift rings carried by the shade panel in laterally spaced part relation from each other and through which respective ones of the first and second cords extend for relative movement during operation, the lift attachments adapted to raise the shade panel into a progressively overlapping array of folds as the shade panel is raised by the first and second cords and lower the shade panel into a progressively non-overlapping position as the shade panel is lowered by the first and second cords;
(e) a valence covering the top rail; and
(f) complementary touch fastener retention straps for encircling and retaining the shade panel in its raised position.
